(19) United States
(12) Patent Application Publication
(10) Pub. No.: US 2024/0172889 A1
(43) Pub. Date: May 30, 2024

(54) Control Box for a Cooking Appliance and Cooking Appliance

(71) Applicant: Topinox Sarl, Wittenheim (FR)

(72) Inventors: Heinrich FEHN, Wittenheim (FR); Christoph STROBL, Wittenheim (FR); Klaus GRUEHBAUM, Wittenheim (FR)

(21) Appl. No.: 18/525,448

(22) Filed: Nov. 30, 2023

(30) Foreign Application Priority Data
Nov. 30, 2022 (DE) 10 2022 131 743.9

(51) Int. Cl. A47J 36/38; A47J 27/04; A47J 36/36; H05B 6/64; H05B 6/76

(52) U.S. Cl. CPC A47J 36/38; A47J 27/04; A47J 36/36; H05B 6/6402; H05B 6/76; A47J 2027/043; H05B 6/647

(57) ABSTRACT

A control box for a cooking appliance includes a housing, in which at least one steam inlet and at least one steam outlet are present, wherein at least one grid structure for shielding high-frequency radiation is present in the housing, wherein the grid structure is arranged between the steam inlet and the steam outlet with respect to a flow path of the steam, and wherein the grid structure has a plurality of flow channels which form in sections a flow path to the steam outlet for the steam entering through the steam inlet. A cooking appliance is furthermore described.

### FIELD OF THE DISCLOSURE

Embodiments of the present disclosure generally relate to a control box for a cooking appliance which, in particular, enables a cooking product to be cooked using steam, hot air and/or microwaves. Such cooking appliances are also referred to as combi-steamers. The present disclosure furthermore relates to a cooking appliance.

### BACKGROUND

A control box establishes a connection between the cooking chamber and a vent pipe or an appliance outlet, which allows generated steam to be delivered. If required, steam can be reduced in the control box. For this purpose, the steam is guided inside the cooking appliance to the control box in which the steam is reduced by condensation, for example.

In this respect, a control box serves to discharge steam generated in a cooking chamber during a cooking process, such that as little steam as possible escapes at a vent pipe of a cooking appliance. To this end, the steam is guided inside the cooking appliance to the control box in which the steam is to condense. For condensing larger quantities of steam, water is supplied via the water nozzle in the control box. The condensate can then be led to a waste water line via a water outlet.

When viewed over a longer period of time, deposits may however also be formed in the control box, as greasy vapors flow from the cooking chamber into the control box and are also discharged via the control box.

In this respect, the control box establishes a connection between the cooking chamber and an appliance outlet, via which a cooking chamber atmosphere containing a steam component and greasy vapors are discharged.

The cooking chamber atmosphere is (heated) air from the cooking chamber which may include the steam component and greasy vapors.

The different heating modes of a combi-steamer require that a pressure equalization and/or an exchange of fresh air is possible via the control box. In case of an automatic cleaning, it must also be possible to supply and remove a cleaning liquor. It is furthermore necessary to prevent microwave radiation from escaping from the cooking appliance.

This results in conflicting requirements as flow cross-sections which are as large as possible are advantageous for an efficient exchange of fresh air and for the supply and removal of the cleaning liquor. However, no openings, if possible, or openings which are as small as possible should be present for an efficient shielding of microwave radiation.

Thus, there is a need for a control box which fulfills the aforementioned conflicting requirements as efficiently and cost-effectively as possible.

### SUMMARY

According to present disclosure, this object is achieved by a control box for a cooking appliance, comprising a housing, in which at least one steam inlet and at least one steam outlet are present, wherein at least one grid structure for shielding high-frequency radiation (microwave radiation) is present in the housing, wherein the grid structure is arranged between the steam inlet and the steam outlet with respect to a flow path of the steam. The grid structure has a plurality of flow channels which form in sections a flow path to the steam outlet for the steam entering through the steam inlet.

Due to the grid structure, the control box is reliably sealed against the escape of microwave rays. At the same time, the flow channels in the grid structure allow an unhindered exchange of fresh air and cleaning liquor.

It is conceivable that several, for example two separate grid structures are present which are arranged one after the other and at a distance from each other with respect to a flow path of the steam.

Basically, a cooking chamber atmosphere including a steam component and greasy vapors is led through the steam inlet and the steam outlet of the control box.

In other words, the steam inlet of the control box is configured to be in flow communication with a cooking chamber of a cooking appliance, so that a cooking chamber atmosphere including a steam component and greasy vapors can flow from the cooking chamber into the control box via the steam inlet.

Furthermore, the steam outlet of the control box is configured to be in flow communication with an appliance outlet of the cooking appliance, so that the cooking chamber atmosphere including the steam component and the greasy vapors flowing into the control box can be discharged from the control box to the surroundings of the cooking appliance via the steam outlet.

In this respect, the steam inlet of the control box may form an interface to the cooking chamber, whereas the steam outlet of the control box forms an interface to the surroundings of the cooking appliance.

The length of the flow channels in relation to a flow cross-section of an individual flow channel can be selected such that a power level of an electromagnetic wave impinging on the at least one grid structure and having a frequency of 2.4 GHz to 2.5 GHz is attenuated by the grid structure by at least 20 dB, in particular at least 40 dB.

The cooking appliance can thus be operated at a microwave power of up to 2 KW, which corresponds to a power level of approx. 60 dBm. Consequently, due to the attenuation by 40 dB, a power level of approx. 20 dB is achieved, which corresponds to a microwave power of 100 mW. The microwave power is in particular attenuated by a factor of 20,000 by such a grid structure. The attenuation is therefore particularly effective. An equivalent design may be provided for other frequency ranges.

The length of a flow channel extends along the direction in which the steam flows from the steam inlet to the steam outlet.

If several separate grid structures are arranged one after the other, the aforementioned attenuation is achieved by the combination of the several grid structures.

The flow channels do not necessarily extend in a straight line, but may also be curved once or several times.

For example, the length of the flow channels is greater than the material thickness of the grid structure, i.e. the wall thickness. This also contributes to a reliable shielding of high-frequency radiation. In particular, the flow channels are actively formed, as they are not only configured between openings of the grid structure, which anyway does not constitute a flow channel within the meaning of the present disclosure.

According to an example embodiment, the flow channels have a length of at least 20 mm, in particular at least 40 mm. With such a length, microwave radiation is reliably shielded, even if the flow channels have a relatively large flow cross-section. In this way, it is particularly easy to exchange fresh air or to supply or remove the cleaning liquor without impairing the shielding of high-frequency radiation.

Preferably, the at least one grid structure extends over the entire height and/or the entire width of the control box. This means that there is no gap between the grid structure, in particular the edge thereof, and the housing of the control box through which microwave radiation can escape. However, the position at which the grid structure is arranged must not necessarily be the highest or widest position of the control box. The fact that the grid structure extends over the entire height and/or the entire width of the control box also contributes to the flow cross-section for the steam outlet being as large as possible. Furthermore, the stability of the control box is thus increased as the walls of the individual flow channels contribute to the stabilization as longitudinal struts.

According to one embodiment, the grid structure surrounds the steam inlet in a circumferential manner. It is therefore possible to shield microwave rays in all directions at the steam inlet.

The at least one grid structure can generally be annular, wherein an annular structure within the meaning of the application, in addition to grid structures having circular or oval contours, also includes grid structures having circumferentially closed, angular contours, in particular honeycomb-shaped contours. Overall, the individual flow channels thus have a cylindrical shape, a circular-cylindrical shape, for example.

The at least one grid structure may comprise a plurality of partition walls which define the flow channels, wherein the partition walls extend perpendicularly from a housing bottom to a housing top of the housing. The partition walls are therefore supported by the housing top and the housing bottom, as a result of which the grid structure is generally stabilized.

Adjacent flow channels can share one partition wall. In other words, a partition wall defines two adjacent flow channels. The total available flow cross-section can thus be maximized.

In the case of an annular grid structure, as seen in a top view or in cross-section, the at least one grid structure may comprise an annular base, and the partition walls can extend from the upper side and the lower side of the base. In other words, the partition walls are interrupted by the base, which provides additional stabilization. The center of gravity of the grid structure may thus be provided in the area of the base. Furthermore, the base may be provided in the geometric center of the grid structure. In addition, the base connects the individual partition walls, as a result of which the annular grid structure can be prefabricated before installation in the control box.

The base is formed, for example, by a plate (having openings).

The partitions walls and the base are welded together, for example.

In addition to the base, a stabilization may also be attached to the ends of the partition walls facing away from the base and also connect the partition walls to each other. The entire grid structure is thus further stiffened. Preferably, the additional stabilization is respectively also formed by a plate (having openings).

According to an example embodiment, the at least one grid structure is formed by a pipe packet. The individual pipes of the pipe packet per se each form a closed channel. Therefore, an end-face welding of the individual pipes of the pipe packet is sufficient to prevent microwave leakage or the escape of steam at the grid structure. In other words, a longitudinal welding of the channels can be omitted. Compared with a grid structure formed by a cast part, this embodiment has the advantage that no complicated tool is required for manufacturing the grid structure.

It is possible to use standard pipes such as square pipes, for example, for manufacturing the grid structure. The use of square pipes has the advantage that the pipes can be lined up without gaps, which results in a compact design.

A further advantage of a grid structure formed by a pipe packet is that the control box does not require an additional outer wall in the area of the grid structure, but that the outer wall can be formed by the grid structure itself. Specifically, the grid structure can be connected to a front or rear part of the control box in a fluid-tight manner, in particular welded thereto.

Furthermore, four square pipes can be arranged in three rows and in three columns and can be welded together at their longitudinal edges, so that a further flow channel is formed in the middle. A total of five flow channels is thus obtained with only four square pipes.

According to a further embodiment, the at least one grid structure can be formed by a plurality of folded sheet panels. Compared with a pipe packet or a cast part, such a grid structure can have a low weight.

Preferably, the sheet panels are welded along the entire length of the grid structure, a leakage of microwaves or steam being thus reliably prevented.

According to a further embodiment, the grid structure is formed by a cast part. Manufacturing the grid structure as a cast part is particularly suitable if large quantities are produced. Furthermore, a cast part does not required additional processing steps to seal the flow channels against leakage of steam or microwaves.

The cast part can form the outer wall of the control box just like the pipe packet.

The flow channels can have a height and/or width or a diameter of at least 20 mm. In case of a varying height or a varying width of a flow channel such as in a honeycomb structure, the specification relates to the maximum height or the maximum width of the flow channel. Such a dimensioning of the flow channels makes a particularly efficient fresh air exchange through the grid structure possible.

The larger the flow cross-section of the individual flow channels, the longer the flow channels must be to achieve the same level of attenuation of the high-frequency radiation. There is a maximum cross-section which corresponds to the cutoff frequency for the corresponding frequency band.

The control box is in particular configured to deliver a cooking chamber atmosphere obtained via the steam inlet and having a steam component and greasy vapors to the surroundings via the at least one steam outlet. In this respect, not only pure steam, but also greasy vapors are removed via the control box from the cooking chamber from which the cooking chamber atmosphere has been obtained which includes the steam (component) and the greasy vapors. The cooking chamber atmosphere including the steam component and the greasy vapors is thus guided through the control box to be released, i.e. discharged to the surroundings.

Furthermore, the present disclosure relates to a cooking appliance for cooking a cooking product. The cooking appliance comprises a cooking chamber, a microwave source configured to feed high-frequency radiation into the cooking chamber, an appliance outlet to the surroundings of the cooking appliance, and a control box. The control box has a housing in which at least one steam inlet and at least one steam outlet are present. At least one grid structure for shielding high-frequency radiation is present in the housing. The grid structure is arranged between the steam inlet and the steam outlet with respect to a flow path of the steam. The steam inlet is in flow communication with the cooking chamber. The steam outlet is in flow communication with the appliance outlet. The grid structure of the control box thus shields the high-frequency radiation (microwave radiation or microwaves) fed into the cooking chamber by the microwave source so that it cannot escape from the cooking appliance, in particular to the surroundings of the cooking appliance, via the appliance outlet which is in flow communication with the steam outlet.

The appliance outlet of the cooking appliance thus constitutes an outlet of the cooking appliance to the surroundings of the cooking appliance, via which the cooking chamber atmosphere including the steam component and the greasy vapors can be discharged.

The microwave source may be a semiconductor component or an electron tube (a magnetron, for example).

One aspect provides that a flow communication is formed between the cooking chamber and the surroundings of the cooking appliance via the control box. The control box is thus not arranged in the cooking chamber of the cooking appliance or does not divide the cooking chamber into two areas or chambers, but ensures that the cooking chamber atmosphere including the steam component and the greasy vapors present in the cooking chamber can be discharged from the cooking chamber to the surroundings via the control box, provided that this is desired.

In other words, the cooking chamber atmosphere including the steam component and the greasy vapors is discharged outside a housing of the cooking appliance which surrounds the cooking chamber and a technical compartment in which, among other things, the control box can be arranged.

According to a further aspect, the steam outlet is in flow communication with the appliance outlet via a vent pipe. Therefore, the vent pipe extends from the control box, in particular the steam outlet thereof, to the appliance outlet of the cooking appliance, so that the steam and the greasy vapors reach the appliance outlet of the cooking appliance from the steam outlet of the control box via the vent pipe, where the steam and the greasy vapors are then discharged to the surroundings of the cooking appliance.

Basically, the control box thus also permits a pressure equalization between the cooking chamber and the surroundings of the cooking appliance, as the steam inlet is in flow communication with the cooking chamber, whereas the steam outlet is in flow communication with the surroundings of the cooking appliance.

The control box provided in the cooking appliance may be configured in accordance with the aforementioned type, i.e. include the corresponding aspects and properties.

### DESCRIPTION OF THE DRAWINGS

Further advantages and features of the present disclosure will become apparent from the description below and from the accompanying drawings to which reference is made and in which:

FIG. 1 schematically shows a cooking appliance according to the present disclosure having a control box according to the present disclosure,

FIG. 2 shows a grid structure for a control box,

FIG. 3 shows the grid structure from FIG. 2 in a control box,

FIG. 4 shows a further grid structure for a control box,

FIG. 5 shows the grid structure from FIG. 4 in a control box,

FIG. 6 shows a control box according to the present disclosure having a grid structure according to a further embodiment, and

FIG. 7 shows a control box according to the present disclosure having a grid structure according to a further embodiment.

### DETAILED DESCRIPTION

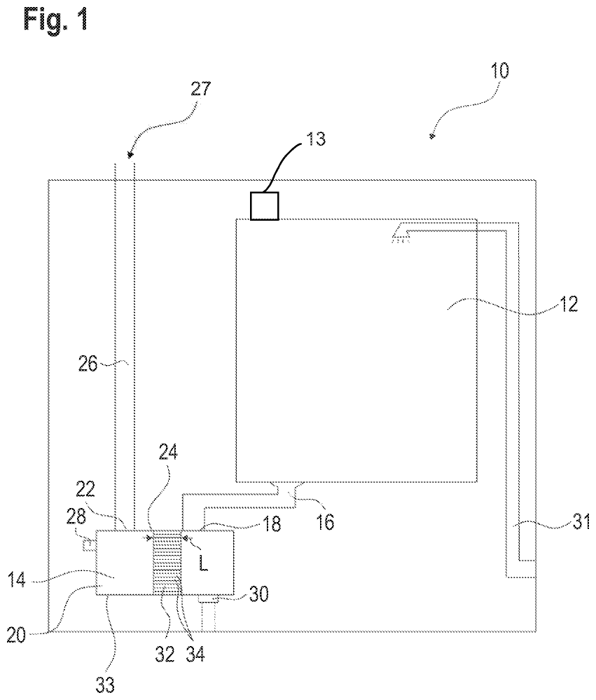

FIG. 1 schematically shows a cooking appliance 10 having a cooking chamber 12 into which a cooking product to be cooked in introduced. The cooking product can be cooked, among others, by means of hot air, steam and microwave radiation. The cooking appliance 10 thus includes at least one microwave source 13 which is configured to feed high-frequency radiation into the cooking chamber 12.

The cooking appliance 10 has a control box 14 which serves to condense steam from the cooking chamber 12. In addition, a pressure equalization between the cooking chamber 12 and the surroundings can take place via the control box 14.

For this purpose, a steam line 16 extends from the cooking chamber 12 to a steam inlet 18 which is formed in a housing 20 of the control box 14.

Non-condensed steam can escape from the control box 14 through a vent pipe 16 via a steam outlet 22 which is also formed in the housing 20, in particular on a housing top 14 of the control box 14.

The vent pipe 26 leads from the control box 14, in particular from the steam outlet 22, to an appliance outlet 27 to the surroundings of the cooking appliance 10.

In this respect, a flow connection is formed between the cooking chamber 12 and the surroundings of the cooking appliance 10 via the control box 14, as the steam inlet 18 is in flow communication with the cooking chamber 12 and the steam outlet 22 is in flow communication with the surroundings of the cooking appliance 10.

Therefore, the pressure equalization between the cooking chamber 12 and the surroundings of the cooking appliance can also take place via the control box 14 (and the vent pipe 26). The vent pipe 26 can be configured to be shorter or longer or even not be provided at all depending on the position of the control box 14 with respect to the appliance outlet 27.

A water nozzle 28 is additionally provided in the housing 20 of the control box 14, via which water can be sprayed into the control box 14 to condense the steam.

Furthermore, a water outlet 30 is present in the housing 20 of the control box 14, via which the condensed steam and the sprayed water can flow off. The cross-section of the water outlet 30 is chosen such that a shielding of the microwaves is ensured. This means that the maximum cross-section is chosen such that it is below the associated critical frequency (cutoff frequency).

The water outlet 30 is provided below the steam inlet 18. Waste water flowing, for example, through the steam inlet 18 into the control box 14, for example after cleaning of the cooking chamber 12, can thus flow off through the control box 14.

In addition, a cleaning liquor supplied to the cooking chamber 12 via a cleaner pipe 31 can flow off via the steam inlet 18 and the water outlet 30.

The water outlet 30 can be arranged in a bottom 33 or in a side wall adjacent to the bottom 33 of the control box 14.

According to the present disclosure, a grid structure 32 is present in the control box 14 for shielding high-frequency radiation (microwave radiation), in particular for shielding high-frequency radiation generated by the microwave source 13 to cook the cooking product in the cooking chamber 12.

With respect to a flow path of the steam, the grid structure 32 is arranged between the steam inlet 18 and the steam outlet 22.

As schematically shown in FIG. 1, the grid structure 32 has a plurality of flow channels 34 which form in sections a flow path to the steam outlet 22 for the steam entering through the steam inlet 18.

The length L of the flow channels 34 in relation to a flow cross-section of an individual flow channel 34 is chosen such that a power level of an electromagnetic wave impinging on the grid structure 32 and having a frequency of 2.4 GHz to 2.5 GHz is attenuated by the grid structure 32 by at least 40 dB.

It must be taken into account that the larger the flow cross-section of the individual flow channels 34, the longer the length of the flow channels 34 has to be to achieve an identical attenuation.

A frequency of 2.4 GHz to 2.5 GHz corresponds to a wavelength in air of approx. 125 mm.

The length L of the flow channels 34 is in particular greater than the material thickness of the grid structure 32, which is illustrated in the following figures. The flow channels 34 are therefore formed structurally and do not merely constitute openings. In the present case, the material thickness refers to the wall thickness of the grid structure 32, i.e. the length or width thereof.

For example, the flow channels 34 have a length L of 20 mm and a height and/or width or a diameter of at least 20 mm.

In a specific example embodiment, the flow channels 34 each have a height and a width of 40 mm and a length of 60 mm.

In an alternative example embodiment, the flow channels 34 are, for example, tubular and have a diameter of 40 mm and a length of 50 mm.

The following figures show different embodiments of the grid structure 32.

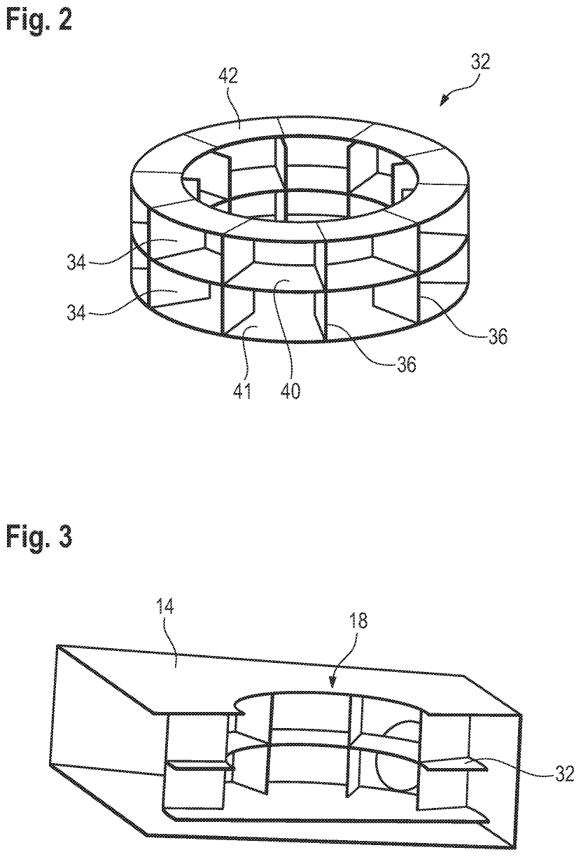

FIGS. 2 and 3 illustrate a grid structure 32 for a control box 14 according to a first embodiment, FIG. 2 representing the grid structure 32 separately, and FIG. 3 showing the grid structure 32 in an installation condition, only part of the control box 14 in the area of the steam inlet 18 being shown for the sake of simplicity.

The grid structure 32 shown in FIGS. 2 and 3 is configured to be annular and, in the installed state, surrounds the steam inlet 18 in a circumferential manner 18.

The annular grid structure 32 is in particular arranged concentrically to the steam inlet 18.

The grid structure 32 extends over the entire height of the control box 14.

The grid structure 32 comprises a plurality of partition walls 36 which define the flow channels 34, the partition walls 36 extending perpendicularly from the housing bottom 33 to the housing top 24 of the housing 20.

The partition walls 36 surround the steam inlet 18 in a star-shape manner.

Therefore, the flow channels 34 widen in a funnel shape in the direction away from the steam inlet 18. In other words, in a top view of the grid structure 32, the flow channels 34 are arranged radially, so that they would notionally intersect in the center as seen in a top view of the grid structure 32.

The grid structure 32 further comprises an annular base 40 which serves to stabilize the grid structure 32.

The partition walls 36 extend from the upper side and from the lower side of the base 40, i.e. on opposite sides of the base 40. The base 40 thus creates the grid which serves to shield the microwave rays.

In the example embodiment, the base 40 is located at half height of the partition walls 36 or of the control box 14. A maximum stabilization of the grid structure 32 is thus achieved.

If a control box 14 having a greater height is present, the base 40 may be present multiple times to obtain a suitable grid structure for shielding microwave rays.

Optionally, as can be seen particularly well in FIG. 2, the grid structure 32 has a further stabilization in the form of a plate 41, 42 (closed or provided with a central opening).

The grid structure 32 illustrated in FIGS. 2 and 3 is formed from sheet-metal parts which are welded together, for example.

A width of the flow channels 34, as measured at the outer circumference of the grid structure 32, is 40 mm, for example.

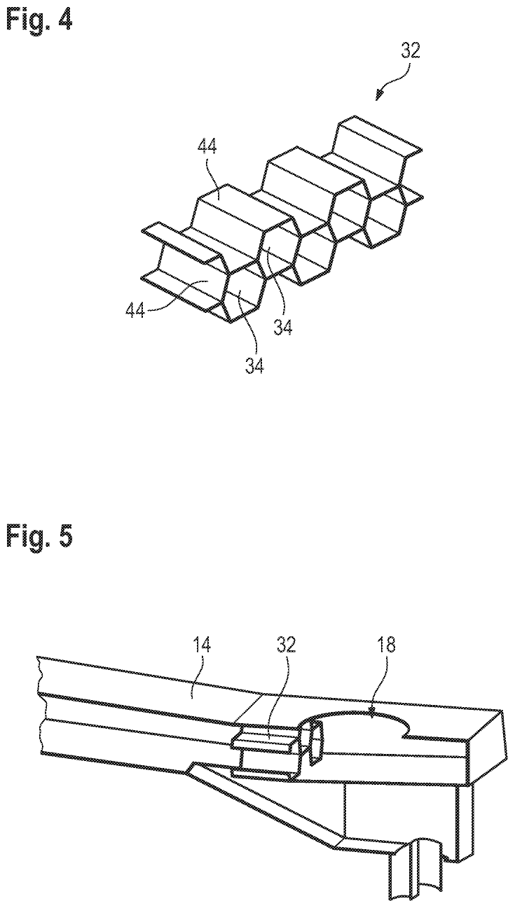

FIGS. 4 and 5 show a grid structure 32 for a control box 14 according to a further embodiment.

The grid structure 32 shown in FIGS. 4 and 5 is formed by a plurality of folded sheet panels 44.

The individual folded sheet panels 44 are stacked one on top of the other so as to form the grid structure 32 with a plurality of flow channels 34.

The sheet panels 44 are connected in the longitudinal direction by a continuous material bond, in particular welded, for fastening, so that the individual flow channels 34 are sealed against each other in a fluid-tight manner in the circumferential direction.

In the example embodiment, the cross-sections of the flow channels 34 are honeycomb-shaped. This results in a generally compact arrangement of numerous flow channels 34. Other shapes are however also conceivable, depending on how the sheet panels 44 are folded. For example, the flow channels 34 can also be rectangular.

As can be seen in FIG. 5, the grid structure 32 extends over the entire height and the entire width of the control box 14. Both the steam and the microwave radiation thus have to pass through the grid structure 32 through the flow channels 34, which ensures an attenuation of the microwave radiation.

The length of the flow channels 34 is greater than a height of the grid structure 32.

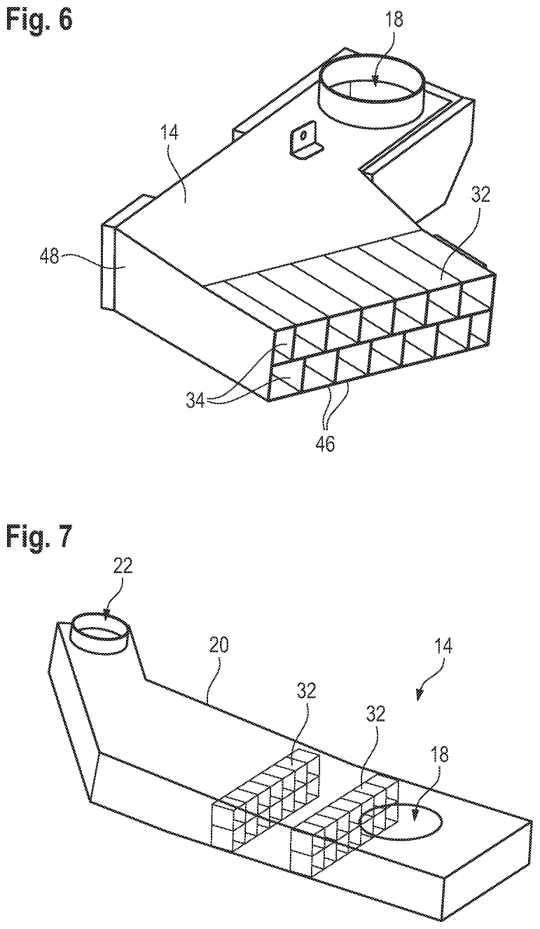

FIG. 6 shows a control box 14 according to a further embodiment having an alternative grid structure 32.

The grid structure 32 illustrated in FIG. 6 is formed by a pipe packet.

In the example embodiment, the pipe packet is composed of square pipes, other pipe shapes being however also conceivable.

The individual pipes 46 of the pipe packet are stacked on top of each other with an offset.

The offset of the pipes 46 simplifies the welding process.

The pipes 46 are in particular not ideally angular, but are slightly rounded at their corners. This results in small openings where the pipes 46 abut each other, which have to be welded so as to be closed. In case the pipes 46 are arranged with an offset from each other, this results in smaller openings than in an arrangement without offset, as a result of which the openings can be closed more easily.

However, an arrangement without offset is also possible.

The pipes 46 are connected to each other at the end faces, in particular connected by a material bond, preferably welded to each other.

Preferably, the pipes 46 are connected to each other in an electrically conductive manner.

In addition, the pipe packet is connected to a front part and a rear part 48 of the control box 14 in a fluid tight manner, in particular welded thereto. This means that the housing 20 is, so to speak, interrupted by the grid structure 32.

FIG. 6 shows for a better view of the grid structure 32 only the rear part 48 of the control box 14.

“Front” and “rear” relate to the flow direction of the steam.

It is also apparent from FIG. 6 that the cross-section of the individual flow channels 34 which are formed by the pipes 46 in the present case must not necessarily be identical.

In a further embodiment which is not represented separately in the figures for the sake of simplicity, the grid structure 32 is formed by a cast part. Basically, the cast part can be shaped similarly to the grid structures 32 shown in FIGS. 2 to 6.

FIG. 7 illustrates a further embodiment of a control box 14.

In contrast to the previously described embodiments, the control box 14 includes two grid structures 32 which are arranged at a distance from each other.

The length of the grid structures 32—as seen with respect to a flow path of the steam—is chosen such that the individual grid structures 32 alone would not generate a sufficient attenuation of microwave radiation. However, a sufficient attenuation is achieved by a combination of the two grid structures 32. The grid structures 32 are in particular arranged in a row.

The grid structures 32 can be arranged spaced apart from each other, as shown in FIG. 7. Alternatively, the grid structures 32 may also be in direct contact with each other.

In FIG. 7, the grid structures 32 are illustrated as pipe packets, it is however also possible to form the grid structures 32 by a cast part or by a plurality of folded sheet panels, as described in connection with the previous embodiments. The two separate grid structures 32 must not necessarily be identical.

Basically, a cooking chamber atmosphere from the cooking chamber 12 having a steam component and greasy vapors can thus be discharged through the steam inlet 18 of the control box 14 and the steam outlet 22 of the control box 14. As the steam outlet 22 is in flow communication with the appliance outlet 27 (via the vent pipe 26), the cooking chamber atmosphere containing the steam component and the greasy vapors can be discharged to the surroundings of the cooking appliance 10. An appropriate flow connection is thus formed between the cooking chamber 12 and the surroundings of the cooking appliance 10 via the control box 14.

As the grid structure 32 arranged in the flow path between the steam inlet 18 and the steam outlet 22 is present in the housing 20 of the control box 14, it is ensured that a connection is established merely by the grid structure 32. In this respect, the steam and the greasy vapors flow through the grid structure 32 to the appliance outlet 27 to be discharged to the surroundings of the cooking appliance 10.

At the same time, the grid structure 32 ensures that the high-frequency radiation generated by the microwave source 13 does not escape from the cooking appliance 10 via the appliance outlet 27, i.e. is emitted to the surroundings of the cooking appliance 10.

1. A control box for a cooking appliance, comprising a housing, in which at least one steam inlet and at least one steam outlet are present, wherein at least one grid structure for shielding high-frequency radiation is present in the housing, wherein the grid structure is arranged between the steam inlet and the steam outlet with respect to a flow path of the steam, and wherein the grid structure has a plurality of flow channels which form in sections a flow path to the steam outlet for the steam entering through the steam inlet.

2. The control box according to claim 1, wherein the length of the flow channels in relation to a flow cross-section of an individual flow channel is selected such that a power level of an electromagnetic wave impinging on the at least one grid structure and having a frequency of 2.4 GHz to 2.5 GHz is attenuated by the grid structure by at least 20 dB.

3. The control box according to claim 1, wherein the length of the flow channels is larger than the material thickness of the grid structure.

4. The control box according to claim 1, wherein the at least one grid structure extends over the entire height and/or the entre width of the control box.

5. The control box according to claim 1, wherein the at least one grid structure surrounds the steam inlet in a circumferential manner.

6. The control box according to claim 5, wherein the at least one grid structure comprises a plurality of partition walls which define the flow channels, the partition walls extending from a housing bottom to a housing top of the housing.

7. The control box according to claim 6, wherein the at least one grid structure comprises an annular base, and in that the partition walls extend from the upper side and the lower side of the base.

8. The control box according to claim 1, wherein the at least one grid structure is formed by a pipe packet.

9. The control box according to claim 1, wherein the at least one grid structure is formed by a plurality of folded sheet panels.

10. The control box according to claim 1, wherein the at least one grid structure is formed by a cast part.

11. The control box according to claim 1, wherein the flow channels have a height and/or width or a diameter of at least 20 mm.

12. The control box according to claim 1, wherein the control box is configured to discharge a cooking chamber atmosphere obtained via the steam inlet and containing a steam component and greasy vapors to the surroundings via the at least one steam outlet.

13. A cooking appliance for cooking a cooking product, comprising a cooking chamber, a microwave source configured to feed high-frequency radiation into the cooking chamber, an appliance outlet to the surroundings of the cooking appliance, and a control box, wherein the control box has a housing in which at least one steam inlet and at least one steam outlet are present, wherein at least one grid structure for shielding high-frequency radiation is present in the housing, wherein the grid structure is arranged between the steam inlet and the steam outlet with respect to a flow path of the steam, wherein the steam inlet is in flow communication with the cooking chamber, and wherein the steam outlet is in flow communication with the appliance outlet.

14. The cooking appliance according to claim 13, wherein a flow communication is formed between the cooking chamber and the surroundings of the cooking appliance via the control box.

15. The cooking appliance according to claim 13, wherein the steam outlet is in flow communication with the appliance outlet via a vent pipe.
